(19) United States
(12) Patent Application Publication
(10) Pub. No.: US 2026/0072707 A1
(43) Pub. Date: Mar. 12, 2026

(54) Adaptive Dashboard with Real-Time Layout Modifications

(71) Applicant: Oracle International Corporation, Redwood Shores, CA (US)

(72) Inventors: Jennifer Darmour, Seattle, WA (US); Orry Soegiono, Bellevue, WA (US); Micah Lawler Sonderman, San Antonio, TX (US)

(73) Assignee: Oracle International Corporation, Redwood Shores, CA (US)

(21) Appl. No.: 18/954,036

(22) Filed: Nov. 20, 2024

Related U.S. Application Data
(60) Provisional application No. 63/692,131, filed on Sep. 8, 2024.

(51) Int. Cl. G06F 9/451

(52) U.S. Cl. CPC G06F 9/451

(57) ABSTRACT

Techniques for an adaptive dashboard layout based on state information associated with a target entity are disclosed. A system monitors the state information associated with a target entity.

Based on the state information, the system identifies a state currently associated with the target entity. Based on the state(s), the system selects a dashboard layout comprising a first set of fields corresponding to a first plurality of data types. Based on and subsequent to the selection of the dashboard layout comprising the first set of fields, the system accesses a set of values of the first plurality of data types to populate the first set of fields. The system generates, for display on a computing device, a first dashboard interface with the first dashboard layout and comprising the first set of values.

### TECHNICAL FIELD

The present disclosure relates to digital devices. In particular, the present disclosure relates to dashboard technology for digital devices.

### BACKGROUND

The ubiquity of digital devices has made them indispensable in the modern world. People often use their digital devices, particular hand-held mobile devices, for work and/or leisure tasks. In particular, people use their digital devices to operate applications and/or services that view various information about other people. Given the amount of information to display and the substantial sizes of many digital device screens, people often have trouble visualizing the information being presented.

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

### BRIEF DESCRIPTION OF THE DRAWINGS

The embodiments are illustrated by way of example and not by way of limitation in the figures of the accompanying drawings. It should be noted that references to “an” or “one” embodiment in this disclosure are not necessarily to the same embodiment, and they mean at least one. In the drawings:

FIG. 1 illustrates a system in accordance with one or more embodiments;

FIG. 2 illustrates an example set of operations for adapting a dashboard layout based entity state in accordance with one or more embodiments;

FIGS. 3A-3C illustrate an example set of dashboard layouts and/or dashboards in accordance with one or more embodiments; and

FIG. 4 shows a block diagram that illustrates a computer system in accordance with one or more embodiments.

### DETAILED DESCRIPTION

In the following description, for the purposes of explanation, numerous specific details are set forth to provide a thorough understanding. One or more embodiments may be practiced without these specific details. Features described in one embodiment may be combined with features described in a different embodiment. In some examples, well-known structures and devices are described with reference to a block diagram form to avoid unnecessarily obscuring the present disclosure.
1. GENERAL OVERVIEW
2. STATE-BASED ADAPTIVE DASHBOARD ARCHITECTURE
3. ADAPTING A DASHBOARD LAYOUT
4. EXAMPLE EMBODIMENT
5. COMPUTER NETWORKS AND CLOUD NETWORKS
6. MICROSERVICE APPLICATIONS
7. HARDWARE OVERVIEW
8. MISCELLANEOUS; EXTENSIONS

### 1. GENERAL OVERVIEW

One or more embodiments select and modify dashboard layouts at runtime based on state information associated with a target entity. Initially, the system monitors state information associated with a target entity. The state information may include location data, time data, a physical activity, an examination type, an online schedule, social media activity, communications from and/or actions by a third-party (e.g., a doctor, a laboratory for testing biological material, and/or the like), or other data corresponding to the target entity. Based on the state information, the system identifies a current state associated with the target entity. A state-to-dashboard layout mapping maps the current state associated with the target entity to a particular layout for a dashboard. The dashboard may, for example, be configured for use by the target entity or for use by another user for viewing information associated with the target entity. The particular layout includes a corresponding set of fields associated with respective data types. Subsequent to and based on the selected layout, the system accesses values of the respective data types to populate the set of fields corresponding to the particular layout. As the state information is updated, the system periodically, or continuously, determines the current state for the target entity. Thereafter, the system modifies the dashboard layout (and data) based on the current state.

In an example, a patient dashboard is updated based on a patient's location in a medical facility, such a hospital, and/or a step in a medical procedure. When the patient walks into the reception area of a doctor's office, the patient's insurance information, name, phone number, etc. is shown on the patient dashboard to a receptionist. When the patient walks inside an examination room for an initial discussion with an intake nurse, the patient's last-measured weight, blood pressure, etc. is shown on the patient dashboard. When the intake nurse leaves and a doctor begins examination of the patient in the examination room, the patient's detailed data related to the visit is shown at the top of the patient dashboard. The one or more embodiments continually reorganize the dashboard, presenting information from the medical records based on a current status/stage associated with the patient corresponding to the medical records. As a result, the most relevant information is floated to the top or presented in a more visible area of a computing device's electronic display. In one example, the relevant information for the patient may be determined/shown as a function of (a) reason for patient visit, (b) diagnosis of patient, and/or (c) queries/search results displayed in another window being related to the information.

One or more embodiments described in this Specification and/or recited in the claims may not be included in this General Overview section.

### 2. ADAPTIVE DASHBOARD ARCHITECTURE

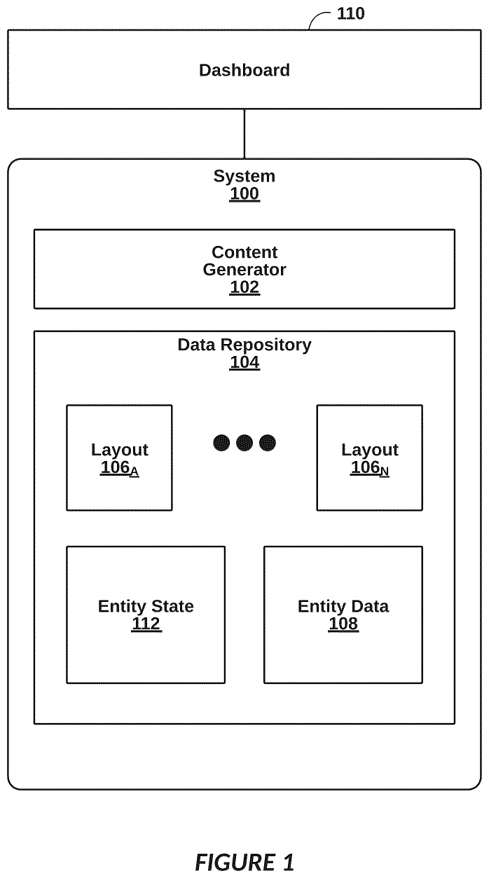

FIG. 1 illustrates a system 100 in accordance with one or more embodiments. As illustrated in FIG. 1, system 100 includes a content generator 102 and a data repository 104. In one or more embodiments, the system 100 may include more or fewer components than the components illustrated in FIG. 1. The components illustrated in FIG. 1 may be local to or remote from each other. The components illustrated in FIG. 1 may be implemented in software and/or hardware. Each component may be distributed over multiple applications and/or machines. Multiple components may be combined into one application and/or machine. Operations described with respect to one component may instead be performed by another component.

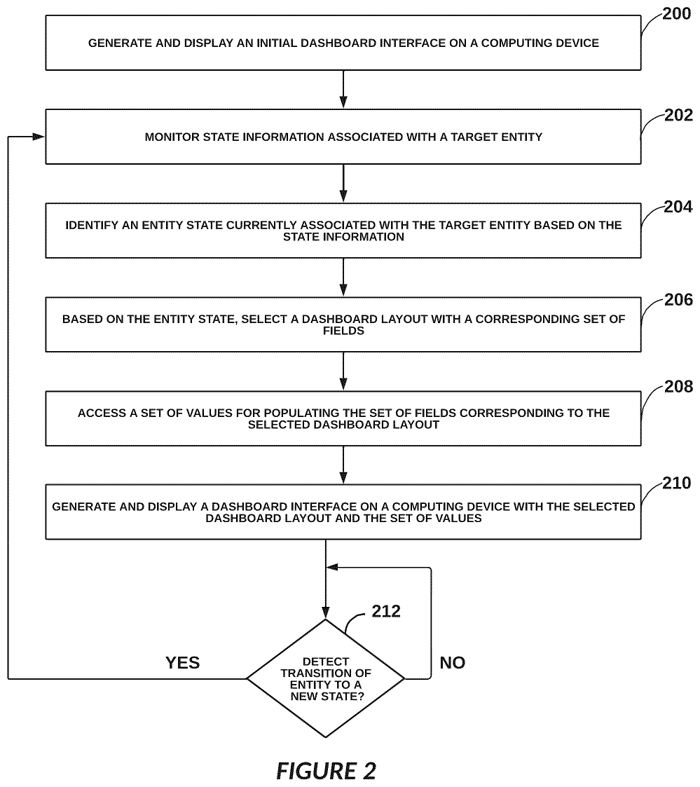

In one or more embodiments, the system 100 refers to hardware and/or software configured to perform operations described herein for adapting a dashboard layout. Examples of operations for adapting a dashboard layout are described below with reference to FIG. 2. The system 100 is implemented on one or more digital devices. The term “digital device” generally refers to any hardware device that includes a processor. A digital device may refer to a physical device executing an application or a virtual machine. Examples of digital devices include a computer, a tablet, a laptop, a desktop, a netbook, a server, a web server, a network policy server, a proxy server, a generic machine, a function-specific hardware device, a hardware router, a hardware switch, a hardware firewall, a hardware firewall, a hardware network address translator (NAT), a hardware load balancer, a mainframe, a television, a content receiver, a set-top box, a printer, a mobile handset, a smartphone, a personal digital assistant (PDA), a wireless receiver and/or transmitter, a base station, a communication management device, a router, a switch, a controller, an access point, and/or a client device.

Additional embodiments and/or examples relating to computer networks are described below in Section 5, titled “Computer Networks and Cloud Networks.”

A dashboard 110 generally represents user interface technology typically used by digital devices, such as hand-held devices, to present content to a device user. In one or more embodiments, the dashboard 110 generally refers to hardware and/or software configured to facilitate communications between a user and a target entity and/or a third party. Examples of interfaces include a graphical user interface (GUI), a command line interface (CLI), a haptic interface, and a voice command interface. Examples of user interface elements include checkboxes, radio buttons, dropdown lists, list boxes, buttons, toggles, text fields, date and time selectors, command lines, sliders, pages, and forms.

In an embodiment, different components of the dashboard 110 are specified in different languages. The behavior of user interface elements is specified in a dynamic programming language such as JavaScript. The content of user interface elements is specified in a markup language, such as hypertext markup language (HTML) or XML User Interface Language (XUL). The layout of user interface elements is specified in a style sheet language such as Cascading Style Sheets (CSS). Alternatively, the dashboard 110 is specified in one or more other languages, such as Java, C, or C++.

The dashboard 110, in general, presents user interface elements as output and receives input via the user interface elements. In one embodiment, the dashboard 110 displays a plurality of fields for presenting a set of values corresponding to a plurality of data types. An arrangement of the plurality of fields may be determined by one of the dashboard layouts 106. Each of the dashboard layouts 106 may map to a particular state due to presenting information corresponding to the particular state, and a different dashboard layout can be used in response to a change in the particular state.

In one or more embodiments, a data repository 104 is any type of storage unit and/or device (e.g., a file system, database, collection of tables, or any other storage mechanism) for storing data. Furthermore, a data repository 104 may include multiple different storage units and/or devices. The multiple different storage units and/or devices may or may not be of the same type or located at the same physical site. Furthermore, a data repository 104 may be implemented or executed on the same computing system as the system 100. Additionally, or alternatively, a data repository 104 may be implemented or executed on a computing system separate from the system 100. The data repository 104 may be communicatively coupled to the system 100 via a direct connection or via a network. Information describing dashboard layouts 106₁-106_{N} and state information 112 may be implemented across any of components within the system 100. However, this information is illustrated within the data repository 104 for purposes of clarity and explanation.

A dashboard layout (e.g., layout 106a to layout 106n) specifies the data types to be included in a dashboard. A particular dashboard layout may specify a subset of the available information corresponding an entity or corresponding to multiple entities. Different dashboard layouts may correspond to different subsets of information. Furthermore, a dashboard layout may specify a location of different data types within the dashboard. As an example, the dashboard layout for a vehicle repair shop may specify that the vehicle's condition (e.g., in queue for repair, in shop for repairs, or repaired) is shown on the top right of the dashboard. Another dashboard layout for the vehicle repair shop may include a total amount due on the top right of the dashboard. Various dashboard layouts may be specified using corresponding dashboard templates.

In one embodiment, the entity state 112 includes state information regarding a target entity. The state information can be generated from tracking a target entity and recording any indicia of a new state or a change in state. There are a number of hardware/software tools available to the system 100 for collecting the state information for the target entity. The entity state 112 may be determined as a function of location data, time data, sensor data, a physical activity, an examination type or protocol, an online schedule, social media activity, communications from a third-party (e.g., a doctor), or other data corresponding to the target entity. Data sources for state information may include a GPS-enabled mobile device, such as a smartphone or a tablet, that can provide various indications of the current state associated with the target entity. In one example, the entity state 112 includes location information provided by the GPS-enabled mobile device. The location information may include GPS coordinates corresponding to the target entity. In another example, the entity state 112 includes location information received from a third-party source such as a nurse who is involved in the target entity's care. In this example, the state information may identify a particular room in which a patient is located. The state information may indicate a stage in a process being completed by a target entity. In an example, the state information identifies one of a receptionist, a nurse, or a doctor that is currently with the patient.

The content generator 102 represents one or more software components generally configured to render digital content for presentation on an electronic display. A user of the system 100, the target entity, and/or a third party may view such content on the dashboard 110. In one embodiment, the content generator 102 renders the digital content to present at least a subset of entity data 108 corresponding to a target entity. The entity data 108 may include any information directly associated with the target entity and/or supplemental information that is indirectly associated with the entity. In one example, the entity data that is directly associated with an entity includes a patient's medical history. Entity data is indirectly associated with the entity includes the patient's family members'medical history.

The entity data 108 may include information corresponding to multiple entities. In an example, a dashboard is generated in association with a doctor's examination of a patient. The entity data 108 that is presented within the dashboard may include information extracted from the patient's medical record. Furthermore, the entity data 108 may include a list of appointments for the doctor extracted from the doctor's scheduling application.

In one embodiment, the content generator 102 generates an initial rendering of digital content according to a particular dashboard layout selected from the dashboard layouts 106. Based on the state, the system 100 may select a next dashboard layout of the dashboard layouts 106, causing the content generator 102 to generate a next rendering of the digital content according to the next dashboard layout of the dashboard layouts 106.

In one embodiment, the content generator 102 may modify a current dashboard layout of the set of dashboard layouts 106 by rearranging and/or modifying the digital content being displayed on the dashboard 110. The content generator 102 may modify the current dashboard layout by first selecting the next dashboard layout in response to a change in the state 112 and then generating a second rendering of the digital content as directed by the next dashboard layout. In one embodiment, the next dashboard layout 106 includes interface elements that present various sets of information in view of the change in the entity state 112. By doing so, the content generator 102 that is relevant to the current entity state 112 corresponding to the target entity.

### 3. ADAPTING A DASHBOARD LAYOUT

FIG. 2 illustrates an example set of operations for adapting a dashboard layout in accordance with one or more embodiments. One or more operations illustrated in FIG. 2 may be modified, rearranged, or omitted. Accordingly, the particular sequence of operations illustrated in FIG. 2 should not be construed as limiting the scope of one or more embodiments.

In one embodiment, the system generates and displays an initial dashboard interface on a computer device (Operation 200). The system may generate content for the initial dashboard interface based on a static dashboard layout or an initial state of a target entity. The system may render a plurality of fields corresponding to a plurality of data types, access a set of values for populating the set of fields, and lastly, display the corresponding values for the plurality of fields based on the static dashboard layout. The system may use the static dashboard layout to coordinate (at least in part) an arrangement of the plurality of fields and their corresponding values.

Alternatively, the system may first determine a current state, second select a corresponding initial dashboard layout, and then generate the content for the initial dashboard interface based on the selected initial dashboard layout. In one alternative embodiment, the system omits Operation 200 and proceeds to Operation 202.

In one embodiment, the system monitors state information associated with a target entity (Operation 202). The system may monitor the state information associated with the target entity in a variety of ways, for example, by monitoring location data, time data, an online schedule, social media activity, communications from a third-party (e.g., a doctor), or the target entity, among others. The system may monitor different types of state information associated respectively with multiple target entities.

As described herein, the system may leverage a number of data sources for monitoring the target entity and determining a current state of the target entity (or multiple target entities). A computing device operated by the target entity may provide the system with access to one or more of these data sources. The system may rely on, as one example data source, a GPS module, possibly embedded in the above computer device, that can provide the state information. The system may monitor the state information, for instance, by receiving notifications from the GPS module regarding movement by the target entity into or out of a particular location.

The system also may monitor the state information by receiving data generated by a GPS-enabled software application running on the above computing device. The ubiquity of computing devices has made them indispensable in the modern world, and people, such as the target entity, often use their computing devices to operate applications and/or services that publish various information about their daily activities and schedules.

The system may rely on, as another example data source, a third party with some interest in the target entity for monitoring the target entity and determining a state of the target entity. The third party may be medical personnel who are entrusted to provide accurate state information associated with the target entity.

In one embodiment, monitoring state information associated with a target entity may include determining the target entity or target entities associated with a dashboard. As a new combination of target entities are identified, the statement information associated with each of the target entities in the new combination of target entities may be identified.

In one embodiment, the system identifies a state a currently associated with the target entity based on the state information (Operation 204). The system may leverage the above-mentioned data sources and/or other data sources for monitoring the target entity and determining a current state of one or more target entities. The system may detect a change from a previous state to the current state of the target entity. In one embodiment, the system may rely on the above-mentioned GPS module to provide various indications of the current state and/or a different state from the previous state associated with the target entity. The system may monitor the target entity and determine any change in the state associated with the target entity, for instance, by accessing location data provided by the GPS module and determining if the location data indicates a transition to the new state.

In one embodiment, the system may rely on various applications running on the target entity's computing device and/or a third-party's computing device for providing various indicia of a change in the current state associated with the target entity. The system may monitor the current state and/or the change in the current state by accessing message data sent by the target entity's computing device and/or a third-party's computing device. The system may monitor the target entity for a change in the current state to the new state in a number of other ways, for example, by accessing an online schedule, social media feeds, notifications from specific locations (e.g., a hospital camera), and other data sources.

The system may monitor the target entity for a change in the current state to the new state using a combination of data sources and applications. To illustrate by way of example, if the target entity walks into a hospital, the embedded GPS module on the target entity's smartphone may automatically transmit a notification to the system on which the dashboard interface is displayed. Instead of an automatic transmission, another data source would be information provided by the target entity him/herself. The target entity may enter a new state into the smartphone and have that information transmitted to the system on which the dashboard interface is displayed. The present application envisions a number of additional ways for the dashboard user to monitor the target entity for transitions to a new state.

In one embodiment, the system selects a dashboard layout with a corresponding set of fields based on the detected entity state of one or more target entities (Operation 206). As described herein, the new entity state may map to the different dashboard layout for a number of reasons. As one reason, the new state and/or the change in state may affect the relevancy of certain values present on a current dashboard layout. The system can select the different dashboard layout to ensure more relevant values are presented in a user interface position of provenance. The user of the computing device on which the dashboard is displayed should benefit from being able to quickly and easily view the more relevant values on the dashboard interface.

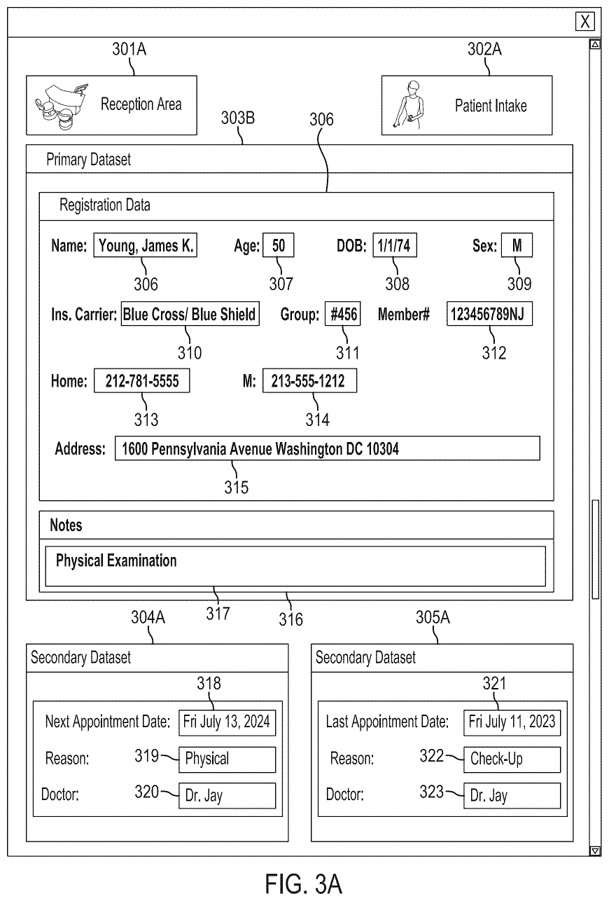

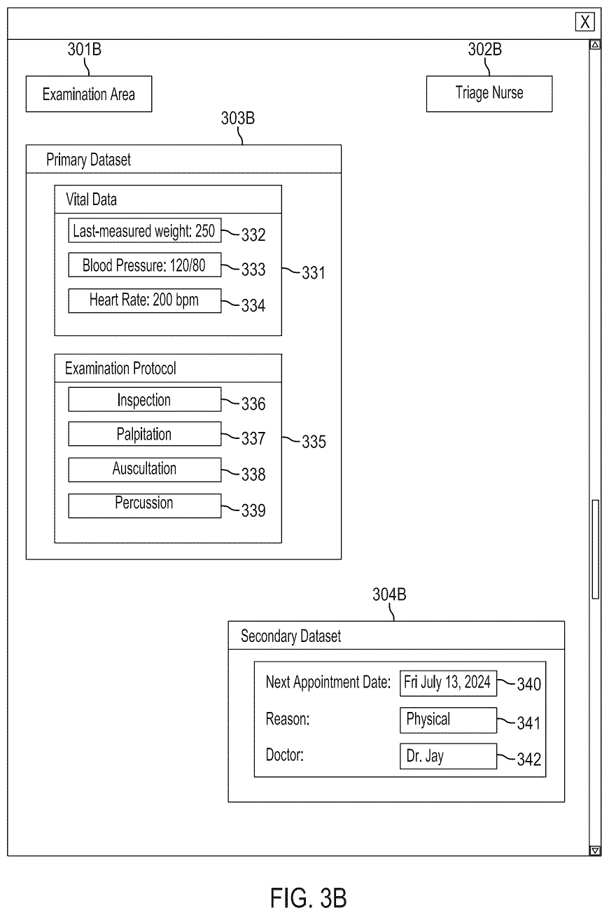

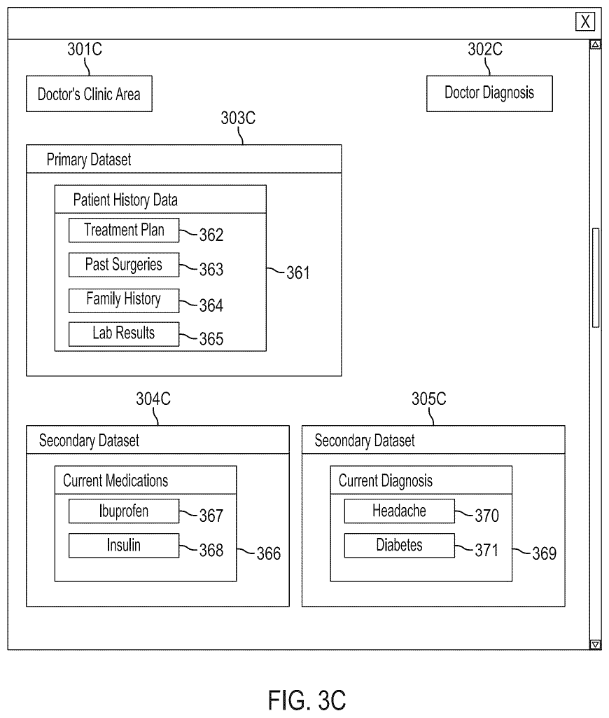

The system may select a dashboard layout that is based on a type of process or procedure being performed in related to a target entity. In an example, the system selects a first dashboard layout for use by a receptionist based on the patient being located in a reception area of a medical office, as shown in FIG. 3A. The system selects a second dashboard layout for use by a nurse while examining a patient, as shown in FIG. 3B. The system selects a selects a third dashboard layout, different than the first dashboard layout, for use by a doctor examining the same patient, as shown in FIG. 3C. Accordingly, the system updates the dashboard layouts in response to detecting a change in the state information and/or state associated with a target entity.

In an embodiment, the system selects a dashboard layout based on a set of states respectively associated with multiple target entities. In an example, the system displays a dashboard in a vehicle repair shop. The target entities include various components of a vehicle. The system determines a state of each target entity. Based on the respective state of each vehicle component, the system determines whether to include an interface element, within a dashboard, to represent the vehicle component. Furthermore, the system determines the information to display for the vehicle component based on the state of the vehicle component. A high-detail layout may be selected for displaying information regarding a vehicle component with a significant number of issues. A low-detail layout may be selected for displaying information regarding a vehicle component with no or minor issues.

In one embodiment, the system accesses a set of values for populating the set of fields (Operation 208). The system may retrieve the set of values from one or more databases storing data associated with the target entity. In one example, the set of values may include financial records for different assets in a commercial enterprise such as a showroom full of cars for sale. In one example, the set of values may include medical records and other health-related information for the target entity.

In one embodiment, the system retrieves a set of values for display on an adaptive and dynamic dashboard interface for a medical patient that is transitioning between departments in a medical facility, such a hospital, and/or through stages in a medical procedure. In another embodiment, the system retrieves a set of values for display on an adaptive and dynamic dashboard interface for an employee who is moving between work areas of a car manufacturing plant based on a current build stage of a car and/or a technician who is currently working on the car. The state information for the above embodiments may include location data and, possibly, time data.

In one embodiment, the system generates and displays a new dashboard interface on a computing device (Operation 210). The system may render a modification and/or rearrangement of the plurality of fields corresponding to the plurality of data types. However, given the new state, the system positions more relevant values in an area with better visibility. In one embodiment, the system generates an adaptive and dynamic dashboard interface for an employee at a car manufacturing plant managing each stage of a build process of a car.

In another embodiment, the system generates an adaptive and dynamic dashboard interface for a medical patient who is transitioning between departments in a medical facility, such a hospital, and/or through stages in a medical procedure. The system continuously updates the dashboard interface based on the medical patient's current location in the medical facility and/or the patient's current stage in the medical procedure. A doctor or nurse may view the dashboard interface to assist them in correctly treating the patient and providing appropriate medical care through each location in the medical facility and/or stage in the medical procedure. A third party, such as another doctor or nurse, may view the dashboard interface while the doctor or nurse is helping the patient make such transitions.

In one embodiment, the system continually reorganizes the adaptive and dynamic dashboard interface for presenting information from the medical records based on a current status/stage associated with the patient corresponding to the medical records. To illustrate by way of the above-mentioned dynamic dashboard interface for the medical patient, when the patient walks into the reception area of a doctor's office, the patient's insurance information, name, phone number, etc. is shown on the dynamic dashboard interface. When the patient walks inside to the triage area and/or intake nurse, the patient's last-measured weight, blood pressure, etc. is shown at a different layout area of the dynamic dashboard interface. When the patient enters the examination room, the patient's detailed data related to the visit is shown at the top of the patient's dynamic dashboard interface. As a result, the most relevant information is floated to the top or a presented in a more visible area of a computing device's electronic display. In one embodiment, the relevant information for the patient may be determined/shown as a function of (a) reason for patient visit, (b) diagnosis of patient, and/or (c) queries/search results related to any information being displayed in the dynamic dashboard interface.

In one embodiment, the system determines if any of a set of target entities have transitioned to a new state, or if there is a change in the set of target entities associated with the dashboard. If the system determines that the state information indicates a transition to the new state (Option YES), the system returns to Operation 202 and repeats the above set of operations to account for the change in the state information associated with the target entity. In one embodiment, the system may rely on the above-mentioned GPS module for providing various indications of the new state and/or any change to the current state associated with the target entity. For instance, if the target entity is a patient in a hospital setting, any movement to a new hospital wing or out of the hospital may constitute a transition to the new state for the target entity. If, on the other hand, the system determines that the state information indicates a same state and/or no change in the state information (Option NO), the system continues to monitor the state.

### 4. EXAMPLE EMBODIMENT

A detailed example is described below for purposes of clarity. Components and/or operations described below should be understood as one specific example that may not be applicable to certain embodiments. Accordingly, components and/or operations described below should not be construed as limiting the scope of any of the claims.

FIGS. 3A to 3C illustrate an example set of dashboards that the system transitions through in response to detecting a change in entity state of one or more target entities and/or a change in the combination of target entities associated with the dashboard.

An example dashboard as described herein presents content to a dashboard viewer/user and can be partitioned into a first portion and a second portion for presenting content related to an intended dashboard user, the entity state, and/or the entity him/herself. FIGS. 3A to 3C illustrate example embodiments in which each example dashboard of the example set of dashboards presents content related to a patient, a receptionist, a triage nurse, and/or a doctor; such content consists of a top portion for any content related to a current state of related to a patient, a receptionist, a triage nurse, and/or a doctor. Underneath the top portion, a bottom portion consisting of a view into the patient data based on the current patient state. Each of the FIGS. 3A-3C depicts the bottom portion of the dashboard interface as an arrangement of interface elements into a primary section and at least one secondary section for presenting the view of the patient data.

FIG. 3A illustrates a dashboard 300A that is presented to a receptionist during a registration (i.e., check-in) process for a patient, while the patient is determined to be in a reception area 301A of a medical facility. The reception area 301A generally operates as a state indicator icon indicative of a likely current location of the patient. The reception area 301A is denoted in FIG. 3A by way of a representative icon of a reception area in a medical facility.

The receptionist intake 302A indicates an intended role of the dashboard user, particularly, that the intended dashboard user is a receptionist. The receptionist intake 302A (i.e., a role identifier icon) is denoted in the dashboard layout depicted in FIG. 3A by way of a representative icon for a receptionist role. The registration process typically involves the receptionist and the patient completing the receptionist intake 302A, which includes a form document with a plurality of form fields.

Below both the reception area 301 and the receptionist intake 302A, the dashboard 300A includes a plurality of interface elements for presenting a plurality of patient attribute values. As illustrated in FIG. 3A, the dashboard 300A includes separate groups of interface elements for displaying respective values of a primary dataset 303A, a secondary dataset 304A, and a secondary dataset 305A. The primary dataset 303A refers to a set of patient attribute values for completing the patient intake 302A. The receptionist may enter, as input for the patient intake 302A, at least one of the set of patient attribute values into one or more of the plurality of form fields. Alternatively, another party populates at least a portion of the plurality of form fields of the patient intake 302A with the at least one of the set of patient attribute values.

The dashboard 300A further presents, via the interface elements for the primary dataset 305A, a portion of the patient intake 302A that comprises a number of form fields for receiving/presenting registration data 306. The number of form fields for the registration data 306 are illustrated in FIG. 3A as a group under associated label “Registration Data 306.” FIG. 3A further illustrates the form fields for the registration data 306 using 4 lines of content, in particular, patient attribute values for name 306, age 307, date of birth (DOB) 308, and sex 309 in a first line; an insurance carrier 310, group number 311, and member number 312 in a second line; home phone number 313 and mobile number 314 in a third line; and an address 315 in a fourth line.

The dashboard 300A further presents, via the interface elements for the primary dataset 305A, a portion of the patient intake 302A that comprises a form field for notes 316.

Here, the receptionist can enter any information that might be helpful to anyone looking at the patient intake 302A, such as another dashboard user when providing care to the patient. As illustrated in FIG. 3A, the receptionist has entered “Physical Examination” as a reference to a possible reason for this current visit 317 and a link to an upcoming appointment in the secondary dataset 305A. The notes 316 can also be used to reference a previous appointment of the patient.

Providing the appropriate patient attribute values for the registration data 306 and the notes 316 to the dashboard 300A completes the patient intake 302A according to one embodiment. Then, by submitting the provided registration data 306 and notes 316, the receptionist completes the registration process according to one embodiment.

The secondary dataset 304A and the secondary dataset 305A, in general, are presented via interface windows that are aligned and occupy a leftmost position and rightmost position, respectively, in FIG. 3A. One or both can be used to provide information for assisting the receptionist in completing the patient intake 302A and/or completing another task. As illustrated in FIG. 3A, the secondary dataset 304A and the secondary dataset 305A provide information on the patient's next appointment and last appointment, respectively. In particular, the patient's next appointment information, depicted for the secondary dataset 304A of FIG. 3A, corresponds to the following attributes: A next appointment date 318, a reason 319, and a doctor 320. Regarding the secondary dataset 305A, FIG. 3A represents the patient's last appointment information in terms of the following attributes: A last appointment date 321, a reason 322, and a doctor 323. It should be noted that any of these attributes and possibly, other attributes can include links that, when activated, execute a process to retrieve additional information.

As an alternative to the above, the secondary dataset 304A and the secondary dataset 305A can be used to provide other forms of helpful information. Examples of such information include one or more patient attribute values for the primary dataset 303A, information to help the receptionist determine one or more patient attribute values for completing the patient intake 302A, and/or additional information regarding the patient.

One example of another task to be completed using the secondary dataset 305A may be to schedule a follow-up appointment. It should be noted that the next appointment may be the reason for the current visit 317, and any information for the next appointment under the secondary dataset 305A may be referenced in the notes 316. One example of another task to be completed using the secondary dataset 304A may be to retrieve any records related to the last appointment.

In one embodiment, the dashboard 300A transitions to a different dashboard layout when the patient intake 301A is completed and the patient changes the state, for instance, by moving to a next stage in their medical procedure and/or the medical facility. In one embodiment, the dashboard 300A transitions to a dashboard layout more suitable to a nurse during an examination process for the patient by the nurse. Given the nature of the nurse's duties, the nurse should benefit from a dashboard interface that reflects a more task-focused dashboard layout.

FIG. 3B illustrates a dashboard 300B that is presented to a nurse during an examination process for a patient by the nurse, while the patient is determined to be in an examination area 301B. The examination area 301B is denoted in FIG. 3B by way of a representative graphic of an examination room in a medical facility. The examination process may be a type of triage-stage patient examination, or simply a triage examination 302B, after.

Similar to the primary dataset 303A and the secondary dataset 304A of dashboard 300A, the dashboard 300B provides content for a primary dataset 303B and a secondary dataset 304B. Similar to FIG. 3A, FIG. 3B positions the content for the primary dataset 303B and the secondary dataset 304B below state indicator icons of the examination area 301B and the triage examination 302B.

To aid the triage nurse, the dashboard 300B presents content for the primary dataset 303B including various types of patient physiological data such as vital data 331. One embodiment of the vital data 331 is illustrated in FIG. 3B as a sensor feed for the patient physiological data. FIG. 3B also illustrates values for patient attributes including a last-measured weight 332, a blood pressure reading 333, a heart rate 334, among others. Each value of these patient attributes can be provided by an active sensor reading or retrieved from previously recorded sensor data. To illustrate, an active cardiovascular sensor device provides periodic readings of the heart rate 334 while the last-measured weight 332 is retrieved from a patient record. A value for the last-measured weight 332, determined by a weight scale, could have been recorded in the past (e.g., at the patient's last appointment) and stored in the patient record to be made available for presentation to the triage nurse when requested by the dashboard 300B.

To further aid the triage nurse in successfully completing the triage examination 302B, the dashboard 300B presents content for an examination protocol 335. One embodiment of the examination protocol 335 is illustrated in FIG. 3B as a task list for a physical examination. FIG. 3B further illustrates descriptive names for the set of tasks in the examination protocol 335, including inspection 336, palpitation 337, auscultation 338, and percussion 339. In addition to the task listing for the examination protocol 335, the dashboard 300B may present content for a step-by-step tutorial of the triage-stage physical examination.

Similar to FIG. 3A, the secondary dataset 304B of FIG. 3B provides information on the patient's next appointment. In particular, the patient's next appointment information, depicted for the secondary dataset 304B of FIG. 3B, corresponds to the following attributes: A next appointment date 336, a reason 337, and a doctor 338. During the course of a task of the examination protocol 335, the triage nurse may use the secondary dataset 304B to schedule a follow-up appointment for the patient.

The dashboard 300B can be adapted for completing any sequence/list of operations while observing vital sensor readings. The triage nurse may use the dashboard 300B for other tasks such as administering a treatment dose and/or providing therapy to the patient. If needed, the triage nurse could also function as a care manager and use the dashboard 300B to view the patient's entire EHR to figure out the patient's long term healthcare needs (e.g., lists of medications, allergies, maintenance, and/or the like).

FIG. 3C illustrates a dashboard 300C that is presented to a doctor during an examination process for the patient by the doctor, while the patient is determined to be in a doctor's clinical area 301C. The examination process refers to a type of doctor-stage patient examination, or simply a doctor examination 302C, where the doctor makes decisions generally regarding the medical care of the patient.

The dashboard 300C presents content in the form of an icon for denoting the doctor's clinical area 301C and an icon for denoting the doctor examination 302C. The icon for denoting the doctor's clinical area 301C may be a representative graphic of a typical clinical area in a medical facility. The icon for denoting the doctor examination 302C may be a representative graphic of a doctor. Alternative, only one of or neither icon are representative graphics. Both icons are indicative of a current state of the patient. In particular, the dashboard 300C presents the icons to inform a viewer that the current state of the patient is to be in the doctor's clinical area 301C to undergo the doctor examination 302C by the doctor. The dashboard 300C also presents the icons to form the viewer that the patient's doctor is intended to be the dashboard user for the current state.

Similar to the primary dataset 303A of the dashboard 300A and the primary dataset 303B of the dashboard 300B, the dashboard 300C provides content for a primary dataset 303C. Similar to FIGS. 3A-3B, FIG. 3C positions the content for the primary dataset 303C below the icons of the doctor's clinical area 301C and the doctor examination 302C. The dashboard 300C also provides content for a secondary dataset 304C and a secondary dataset 305C; similar to FIG. 3A, FIG. 3C positions the content for the secondary dataset 304C and the secondary dataset 305C below the primary dataset 303C.

In one embodiment, the doctor concludes the doctor examination 302C with at least one health malady diagnosis and/or at least one treatment/therapy prescription. In order to reach a conclusion, the doctor reviews the information provided via the content for the primary dataset 303C, the secondary dataset 304C, and/or the secondary dataset 305C. In particular, the doctor relies on patient history data 361 for a detailed patient medical record summary. The dashboard 300C presents content organizing the patient history data 361 into categories, particularly, a treatment plan 362, past surgeries 363, a family history 364, and lab results 365.

The secondary dataset 304C and the secondary dataset 305C are depicted in FIG. 3C as aligned interface windows that occupy a leftmost position and a rightmost position, respectively. One or both can be used to provide information for assisting the doctor's decision-making, for instance, regarding a health malady diagnosis and/or a medication prescription for the patient.

As illustrated in FIG. 3C, the dashboard 300C presents current medications 366 as a list of medication names that includes Ibuprofen 367 and insulin 368. As illustrated in FIG. 3C, the dashboard 300C presents current diagnosis 369 as a list of current maladies for the patient including headache 370 and diabetes 371. The doctor may add, remove, or change any of the listed current medications 366 using the dashboard 300C. The doctor may render a new diagnosis for the current diagnosis and/or correct a previous diagnosis using the dashboard 300C.

The dashboard 300C may be adapted to suit the needs of the doctor. For example, the doctor may also use the dashboard 300C to authorize procedures, coordinate care with insurance companies, and other executive decisions. For each decision, the doctor can use the dashboard 300C to complete a checklist of pre-conditions that must be met before the decision can be acted upon. In one embodiment, the interface window for the current diagnosis 369 may include a doctor decision checklist that when completed, helps confirm a proposed diagnosis.

### 5. COMPUTER NETWORKS AND CLOUD NETWORKS

In one or more embodiments, a computer network provides connectivity among a set of nodes. The nodes may be local to and/or remote from each other. The nodes are connected by a set of links. Examples of links include a coaxial cable, an unshielded twisted cable, a copper cable, an optical fiber, and a virtual link.

A subset of nodes implements the computer network. Examples of such nodes include a switch, a router, a firewall, and a network address translator (NAT). Another subset of nodes uses the computer network. Such nodes (also referred to as “hosts”) may execute a client process and/or a server process. A client process makes a request for a computing service (such as, execution of a particular application, and/or storage of a particular amount of data). A server process responds by executing the requested service and/or returning corresponding data.

A computer network may be a physical network, including physical nodes connected by physical links. A physical node is any digital device. A physical node may be a function-specific hardware device, such as a hardware switch, a hardware router, a hardware firewall, and a hardware NAT. Additionally or alternatively, a physical node may be a generic machine that is configured to execute various virtual machines and/or applications performing respective functions. A physical link is a physical medium connecting two or more physical nodes. Examples of links include a coaxial cable, an unshielded twisted cable, a copper cable, and an optical fiber.

A computer network may be an overlay network. An overlay network is a logical network implemented on top of another network (such as, a physical network). Each node in an overlay network corresponds to a respective node in the underlying network. Hence, each node in an overlay network is associated with both an overlay address (to address to the overlay node) and an underlay address (to address the underlay node that implements the overlay node). An overlay node may be a digital device and/or a software process (such as, a virtual machine, an application instance, or a thread) A link that connects overlay nodes is implemented as a tunnel through the underlying network. The overlay nodes at either end of the tunnel treat the underlying multi-hop path between them as a single logical link. Tunneling is performed through encapsulation and decapsulation.

In an embodiment, a client may be local to and/or remote from a computer network. The client may access the computer network over other computer networks, such as a private network or the Internet. The client may communicate requests to the computer network using a communications protocol, such as Hypertext Transfer Protocol (HTTP). The requests are communicated through an interface, such as a client interface (such as a web browser), a program interface, or an application programming interface (API).

In an embodiment, a computer network provides connectivity between clients and network resources. Network resources include hardware and/or software configured to execute server processes. Examples of network resources include a processor, a data storage, a virtual machine, a container, and/or a software application. Network resources are shared amongst multiple clients. Clients request computing services from a computer network independently of each other. Network resources are dynamically assigned to the requests and/or clients on an on-demand basis.

### 6. HARDWARE OVERVIEW

According to one embodiment, the techniques described herein are implemented by one or more special-purpose computing devices. The special-purpose computing devices may be hard-wired to perform the techniques, or may include digital electronic devices such as one or more application-specific integrated circuits (ASICs), field programmable gate arrays (FPGAs), or network processing units (NPUs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, FPGAs, or NPUs with custom programming to accomplish the techniques. The special-purpose computing devices may be desktop computer systems, portable computer systems, handheld devices, networking devices or any other device that incorporates hard-wired and/or program logic to implement the techniques.

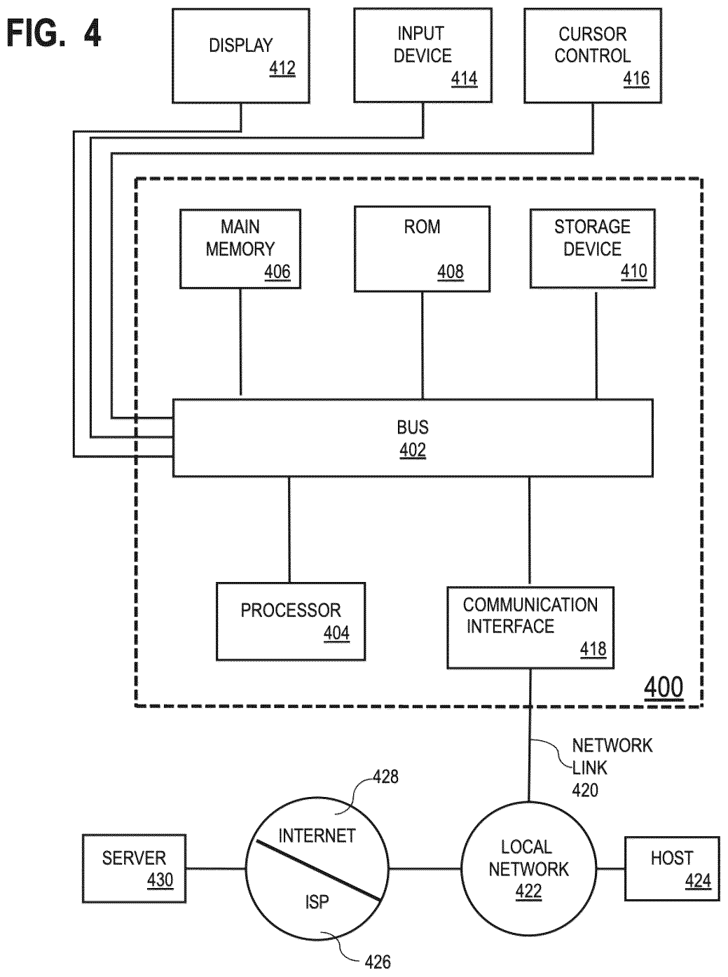

For example, FIG. 4 is a block diagram that illustrates a computer system 400 upon which an embodiment of the disclosure may be implemented. Computer system 400 includes a bus 402 or other communication mechanism for communicating information, and a hardware processor 404 coupled with bus 402 for processing information. Hardware processor 404 may be, for example, a general purpose microprocessor.

Computer system 400 also includes a main memory 406, such as a random access memory (RAM) or other dynamic storage device, coupled to bus 402 for storing information and instructions to be executed by processor 404. Main memory 406 also may be used for storing temporary variables or other intermediate information during execution of instructions to be executed by processor 404. Such instructions, when stored in non-transitory storage media accessible to processor 404, render computer system 400 into a special-purpose machine that is customized to perform the operations specified in the instructions.

Computer system 400 further includes a read only memory (ROM) 408 or other static storage device coupled to bus 402 for storing static information and instructions for processor 404. A storage device 410, such as a magnetic disk, optical disk, or a Solid State Drive (SSD) is provided and coupled to bus 402 for storing information and instructions.

Computer system 400 may be coupled via bus 402 to a display 412, such as a cathode ray tube (CRT), for displaying information to a computer user. An input device 414, including alphanumeric and other keys, is coupled to bus 402 for communicating information and command selections to processor 404. Another type of user input device is cursor control 416, such as a mouse, a trackball, or cursor direction keys for communicating direction information and command selections to processor 404 and for controlling cursor movement on display 412. This input device typically has two degrees of freedom in two axes, a first axis (e.g., x) and a second axis (e.g., y), that allows the device to specify positions in a plane.

Computer system 400 may implement the techniques described herein using customized hard-wired logic, one or more ASICs or FPGAs, firmware and/or program logic which in combination with the computer system causes or programs computer system 400 to be a special-purpose machine. According to one embodiment, the techniques herein are performed by computer system 400 in response to processor 404 executing one or more sequences of one or more instructions contained in main memory 406. Such instructions may be read into main memory 406 from another storage medium, such as storage device 410. Execution of the sequences of instructions contained in main memory 406 causes processor 404 to perform the process steps described herein. In alternative embodiments, hard-wired circuitry may be used in place of or in combination with software instructions.

The term “storage media” as used herein refers to any non-transitory media that store data and/or instructions that cause a machine to operate in a specific fashion. Such storage media may comprise non-volatile media and/or volatile media. Non-volatile media includes, for example, optical or magnetic disks, such as storage device 410. Volatile media includes dynamic memory, such as main memory 406. Common forms of storage media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge, content-addressable memory (CAM), and ternary content-addressable memory (TCAM).

Storage media is distinct from but may be used in conjunction with transmission media. Transmission media participates in transferring information between storage media. For example, transmission media includes coaxial cables, copper wire and fiber optics, including the wires that comprise bus 402. Transmission media can also take the form of acoustic or light waves, such as those generated during radio-wave and infra-red data communications.

Various forms of media may be involved in carrying one or more sequences of one or more instructions to processor 404 for execution. For example, the instructions may initially be carried on a magnetic disk or solid state drive of a remote computer. The remote computer can load the instructions into its dynamic memory and send the instructions over a telephone line using a modem. A modem local to computer system 400 can receive the data on the telephone line and use an infra-red transmitter to convert the data to an infra-red signal. An infra-red detector can receive the data carried in the infra-red signal and appropriate circuitry can place the data on bus 402. Bus 402 carries the data to main memory 406, from which processor 404 retrieves and executes the instructions. The instructions received by main memory 406 may optionally be stored on storage device 410 either before or after execution by processor 404.

Computer system 400 also includes a communication interface 418 coupled to bus 402. Communication interface 418 provides a two-way data communication coupling to a network link 420 that is connected to a local network 422. For example, communication interface 418 may be an integrated services digital network (ISDN) card, cable modem, satellite modem, or a modem to provide a data communication connection to a corresponding type of telephone line. As another example, communication interface 418 may be a local area network (LAN) card to provide a data communication connection to a compatible LAN. Wireless links may also be implemented. In any such implementation, communication interface 418 sends and receives electrical, electromagnetic or optical signals that carry digital data streams representing various types of information.

Network link 420 typically provides data communication through one or more networks to other data devices. For example, network link 420 may provide a connection through local network 422 to a host computer 424 or to data equipment operated by an Internet Service Provider (ISP) 426. ISP 426 in turn provides data communication services through the world wide packet data communication network now commonly referred to as the “Internet” 428. Local network 422 and Internet 428 both use electrical, electromagnetic or optical signals that carry digital data streams. The signals through the various networks and the signals on network link 420 and through communication interface 418, which carry the digital data to and from computer system 400, are example forms of transmission media.

Computer system 400 can send messages and receive data, including program code, through the network(s), network link 420 and communication interface 418. In the Internet example, a server 430 might transmit a requested code for an application program through Internet 428, ISP 426, local network 422 and communication interface 418.

The received code may be executed by processor 404 as it is received, and/or stored in storage device 410, or other non-volatile storage for later execution.

### 7. MISCELLANEOUS; EXTENSIONS

Unless otherwise defined, all terms (including technical and scientific terms) are to be given their ordinary and customary meaning to a person of ordinary skill in the art, and are not to be limited to a special or customized meaning unless expressly so defined herein.

This application may include references to certain trademarks. Although the use of trademarks is permissible in patent applications, the proprietary nature of the marks should be respected and every effort made to prevent their use in any manner which might adversely affect their validity as trademarks.

Embodiments are directed to a system with one or more devices that include a hardware processor and that are configured to perform any of the operations described herein and/or recited in any of the claims below.

In an embodiment, one or more non-transitory computer readable storage media comprises instructions which, when executed by one or more hardware processors, cause performance of any of the operations described herein and/or recited in any of the claims.

In an embodiment, a method comprises operations described herein and/or recited in any of the claims, the method being executed by at least one device including a hardware processor.

Any combination of the features and functionalities described herein may be used in accordance with one or more embodiments. In the foregoing specification, embodiments have been described with reference to numerous specific details that may vary from implementation to implementation. The specification and drawings are, accordingly, to be regarded in an illustrative rather than a restrictive sense. The sole and exclusive indicator of the scope of the disclosure, and what is intended by the applicants to be the scope of the disclosure, is the literal and equivalent scope of the set of claims that issue from this application, in the specific form in which such claims issue, including any subsequent correction.

What is claimed is:

1. A method comprising:
monitoring state information associated with a target entity;
based on the state information detected by the monitoring operation, identifying a first state currently associated with the target entity;
based on the first state: selecting, at runtime, a first dashboard layout comprising a first set of fields corresponding to a first plurality of data types;
based on and subsequent to the runtime selection of the first dashboard layout comprising the first set of fields: accessing a first set of values, of the first plurality of data types, for populating the first set of fields;
generating, for display on a computing device, a first dashboard interface with the first dashboard layout and comprising the first set of values;
displaying the first dashboard interface.

2. The method of claim 1 further comprising:
subsequent to displaying the first dashboard interface:
based on updated state information detected by the monitoring operation, identifying a second state currently associated with the target entity;
based on the second state, selecting a second dashboard layout comprising a second set of fields corresponding to a second plurality of data types, wherein the first dashboard layout is different from the second dashboard layout, and wherein the first plurality of data types is different from the second plurality of data types;
based on and subsequent to the selection of the second dashboard layout comprising the second set of fields: accessing a second set of values, of the second plurality of data types, for populating the second set of fields;
generating, for display on the computing device, a second dashboard interface with the second dashboard layout and comprising the second set of values;
displaying the second dashboard interface.

3. The method of claim 2, wherein the second dashboard interface is displayed on a different computing device than the first dashboard interface.

4. The method of claim 1, wherein the operations further comprise:
based on the state information detected by the monitoring operation, identifying a second state currently associated with the target entity, wherein the target entity is concurrently associated with the first state and the second state;
based on the second state, selecting a second dashboard layout comprising a second set of fields corresponding to a second plurality of data types, wherein the first dashboard layout is different from the second dashboard layout, and wherein the first plurality of data types is different from the second plurality of data types;
based on and subsequent to the selection of the second dashboard layout comprising the second set of fields: accessing a second set of values, of the second plurality of data types, for populating the second set of fields;
generating a second dashboard interface with the second dashboard layout and comprising the second set of values;
displaying the second dashboard interface concurrently with the first dashboard interface.

5. The method of claim 1, wherein a state-to-dashboard mapping maps a plurality of candidate states for the target entity to a plurality of dashboard layouts, wherein the plurality of candidate states comprises the first state, wherein the plurality of dashboard layouts comprises the first dashboard layout, and wherein the first dashboard layout is selected by applying the first state to the mapping to determine the first dashboard layout.

6. The method of claim 1, wherein the state information associated with the target entity comprises a location of the target entity.

7. The method of claim 1, wherein the target entity comprises a patient, and wherein the state information associated with the target entity comprises at least one of: an examination type of an examination being performed on the patient, a procedure type of a procedure being performed on the patient, or a biometric measure detected for the patient.

8. The method of claim 1, wherein the operations further comprise:
monitoring a second state information associated with a second entity;
based on the second state information, identifying a second state currently associated with second target entity;
wherein the first dashboard layout is based further on the second state.

9. The method of claim 1,
subsequent to displaying the first dashboard interface:
based on updated state information detected by the monitoring operation, identifying a second state currently associated with the target entity;
based on the second state, selecting a second dashboard layout comprising a second set of fields corresponding to a second plurality of data types, wherein the first dashboard layout is different from the second dashboard layout, and wherein the first plurality of data types is different from the second plurality of data types;
based on and subsequent to the selection of the second dashboard layout comprising the second set of fields: accessing a second set of values, of the second plurality of data types, for populating the second set of fields;
generating, for display on the computing device, a second dashboard interface with the second dashboard layout and comprising the second set of values;
displaying the second dashboard interface;
wherein the second dashboard interface is displayed on a different computing device than the first dashboard interface;
wherein a state-to-dashboard mapping maps a plurality of candidate states for the target entity to a plurality of dashboard layouts, wherein the plurality of candidate states comprises the first state, wherein the plurality of dashboard layouts comprises the first dashboard layout, and wherein the first dashboard layout is selected by applying the first state to the mapping to determine the first dashboard layout;
wherein the state information associated with the target entity comprises at least one of: a location of the target entity, an examination type of an examination being performed on the target entity, a procedure type of a procedure being performed on the target entity, or a biometric measure detected for the target entity.

10. One or more non-transitory computer readable media comprising instructions that, when executed by one or more hardware processors, cause performance of operations comprising:
monitoring state information associated with a target entity;
based on the first state: selecting, at runtime, a first dashboard layout comprising a first set of fields corresponding to a first plurality of data types;
based on and subsequent to the runtime selection of the first dashboard layout comprising the first set of fields: accessing a first set of values, of the first plurality of data types, for populating the first set of fields;
generating, for display on a computing device, a first dashboard interface with the first dashboard layout and comprising the first set of values;
displaying the first dashboard interface.

11. The non-transitory computer readable media of claim 10, wherein the operations further comprise:
subsequent to displaying the first dashboard interface:
based on updated state information detected by the monitoring operation, identifying a second state currently associated with the target entity;
based on the second state, selecting a second dashboard layout comprising a second set of fields corresponding to a second plurality of data types, wherein the first dashboard layout is different from the second dashboard layout, and wherein the first plurality of data types is different from the second plurality of data types;
based on and subsequent to the selection of the second dashboard layout comprising the second set of fields: accessing a second set of values, of the second plurality of data types, for populating the second set of fields;
generating, for display on the computing device, a second dashboard interface with the second dashboard layout and comprising the second set of values;
displaying the second dashboard interface.

12. The non-transitory computer readable media of claim 11, wherein the second dashboard interface is displayed on a different computing device than the first dashboard interface.

13. The non-transitory computer readable media of claim 10, wherein the operations further comprise:
based on the state information detected by the monitoring operation, identifying a second state currently associated with the target entity, wherein the target entity is concurrently associated with the first state and the second state;
based on the second state, selecting a second dashboard layout comprising a second set of fields corresponding to a second plurality of data types, wherein the first dashboard layout is different from the second dashboard layout, and wherein the first plurality of data types is different from the second plurality of data types;
based on and subsequent to the selection of the second dashboard layout comprising the second set of fields: accessing a second set of values, of the second plurality of data types, for populating the second set of fields;
generating a second dashboard interface with the second dashboard layout and comprising the second set of values;
displaying the second dashboard interface concurrently with the first dashboard interface.

14. The non-transitory computer readable media of claim 10, wherein a state-to-dashboard mapping maps a plurality of candidate states for the target entity to a plurality of dashboard layouts, wherein the plurality of candidate states comprises the first state, wherein the plurality of dashboard layouts comprises the first dashboard layout, and wherein the first dashboard layout is selected by applying the first state to the mapping to determine the first dashboard layout.

15. The non-transitory computer readable media of claim 10, wherein the state information associated with the target entity comprises a location of the target entity.

16. The non-transitory computer readable media of claim 10, wherein the target entity comprises a patient, and wherein the state information associated with the target entity comprises at least one of: an examination type of an examination being performed on the patient, a procedure type of a procedure being performed on the patient, or a biometric measure detected for the patient.

17. A system comprising:
at least one device including one or more hardware processor;
the system being configured to use the one or more hardware processors to execute operations comprising:
monitoring state information associated with a target entity;
based on the first state: selecting, at runtime, a first dashboard layout comprising a first set of fields corresponding to a first plurality of data types;
based on and subsequent to the runtime selection of the first dashboard layout comprising the first set of fields: accessing a first set of values, of the first plurality of data types, for populating the first set of fields;
generating, for display on a computing device, a first dashboard interface with the first dashboard layout and comprising the first set of values;
displaying the first dashboard interface.

18. The system of claim 17, wherein the operations further comprise:
subsequent to displaying the first dashboard interface:
based on updated state information detected by the monitoring operation, identifying a second state currently associated with the target entity;
based on the second state, selecting a second dashboard layout comprising a second set of fields corresponding to a second plurality of data types, wherein the first dashboard layout is different from the second dashboard layout, and wherein the first plurality of data types is different from the second plurality of data types;
based on and subsequent to the selection of the second dashboard layout comprising the second set of fields: accessing a second set of values, of the second plurality of data types, for populating the second set of fields;
generating, for display on the computing device, a second dashboard interface with the second dashboard layout and comprising the second set of values;
displaying the second dashboard interface.

19. The system of claim 18, wherein the second dashboard interface is displayed on a different computing device than the first dashboard interface.

20. The system of claim 17, wherein the operations further comprise:
based on the state information detected by the monitoring operation, identifying a second state currently associated with the target entity, wherein the target entity is concurrently associated with the first state and the second state;
based on the second state, selecting a second dashboard layout comprising a second set of fields corresponding to a second plurality of data types, wherein the first dashboard layout is different from the second dashboard layout, and wherein the first plurality of data types is different from the second plurality of data types;
based on and subsequent to the selection of the second dashboard layout comprising the second set of fields: accessing a second set of values, of the second plurality of data types, for populating the second set of fields;
generating a second dashboard interface with the second dashboard layout and comprising the second set of values;
displaying the second dashboard interface concurrently with the first dashboard interface.

21. The system of claim 17, wherein a state-to-dashboard mapping maps a plurality of candidate states for the target entity to a plurality of dashboard layouts, wherein the plurality of candidate states comprises the first state, wherein the plurality of dashboard layouts comprises the first dashboard layout, and wherein the first dashboard layout is selected by applying the first state to the mapping to determine the first dashboard layout.

22. The system of claim 17, wherein the state information associated with the target entity comprises a location of the target entity.

23. The system of claim 17, wherein the target entity comprises a patient, and wherein the state information associated with the target entity comprises at least one of: an examination type of an examination being performed on the patient, a procedure type of a procedure being performed on the patient, or a biometric measure detected for the patient.
